(19) United States
(12) Patent Application Publication
(10) Pub. No.: US 2012/0098708 A1
(43) Pub. Date: Apr. 26, 2012

(54) ELECTRONIC APPARATUS AND ANTENNA UNIT

(75) Inventor: Nobuaki Takasu, Akishima-shi (JP)

(73) Assignee: KABUSHIKI KAISHA TOSHIBA, Tokyo (JP)

(21) Appl. No.: 13/188,357

(22) Filed: Jul. 21, 2011

(30) Foreign Application Priority Data
Oct. 22, 2010 (JP) 2010-237451

(51) Int. Cl. H01Q 1/24

(52) U.S. Cl. 343/702

(57) ABSTRACT

According to one embodiment, an electronic apparatus comprises a housing with a first surface, an induction electric field antenna, a millimeter-wave antenna, and a close proximity wireless transfer unit. The induction electric field antenna comprises a coupling electrode facing a first region of the first surface. The millimeter-wave antenna is arranged opposed to the first region with the induction electric field antenna between the first region and the millimeter-wave antenna. The millimeter-wave antenna comprises a plurality of millimeter-wave antenna elements. The plurality of millimeter-wave antenna elements are disposed at positions outside an outer periphery of a bottom surface of the induction electric field antenna such that a space near the first region is included in a cover area of the millimeter-wave antenna.

### CROSS-REFERENCE TO RELATED APPLICATIONS

This application is based upon and claims the benefit of priority from Japanese Patent Application No. 2010-237451, filed Oct. 22, 2010; the entire contents of which are incorporated herein by reference.

### FIELD

Embodiments described herein relate generally to an electronic apparatus and an antenna unit for executing close proximity wireless transfer.

### BACKGROUND

In recent years, in IC cards, mobile phones, etc., wireless communication such as NFC (Near Field Communication) has begun to be used. A user can easily execute communication for an authentication process, an accounting process, etc., simply by performing an operation of holding the IC card or mobile phone over a reader/writer module of a host apparatus.

Recently, a novel close proximity wireless transfer technology, which uses an induction electric field, has begun to be used. In this novel close proximity wireless transfer technology, not only authentication and accounting services can be performed between the devices, but also large data files of text data, video data and audio data can be exchanged between the devices.

In this close proximity wireless transfer technology, a signal of an UWB band (about 4 GHz) is transmitted/received by using an induction electric field antenna which is called “coupler”. Thereby, the close proximity wireless transfer technology realizes high-speed, comfortable communication with high security in a very short communication range. The user can execute data transfer, etc. between devices simply by touching one device, which supports the close proximity wireless transfer technology, to a touch point of the other device which supports the close proximity wireless transfer technology.

However, in the close proximity wireless transfer technology using the UWB band, the limit of the communication speed is about 1 Gbps. In order to realize non-compression transfer of high-definition (HD) images, etc., it is required to realize communication at a higher speed (about 4 Gbps). A technology using millimeter waves has begun to be studied as a technology for realizing close proximity communication at the higher speed for executing non-compression transfer of high-definition (HD) images, etc.

In order to make compatible the current close proximity wireless transfer using the UWB band and the close proximity ultra-high-speed wireless transfer of the next generation which uses millimeter waves, two different antennas, namely an induction electric field antenna and a millimeter-wave antenna, are required. From the standpoint of the user, however, it is desirable that the user can execute communication between devices by using the same touch point, in either the case of using the current close proximity wireless transfer or the case of using the close-proximity very-high-speed wireless transfer of the next generation.

As the structure of a composite antenna including two kinds of antennas, for example, there is known an antenna structure wherein a coupling electrode of an induction electric field antenna for the current close proximity wireless transfer and a loop antenna for NFC are disposed on the same plane.

However, since the frequency of millimeter waves is close to the frequency of light, the directivity and rectilinearity of millimeter waves are high. Hence, if the distance between the millimeter-wave antenna and the touch point is too short, the range of the neighborhood of the touch point may not be covered by the millimeter-wave antenna. Thus, if the millimeter-wave antenna and the coupling electrode of the induction electric field antenna are disposed on the same plane, it may become difficult to share the same touch point between the current close proximity wireless transfer and the close-proximity very-high-speed wireless transfer of the next generation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating the system configuration of an electronic apparatus according to an embodiment;

FIG. 2 is an exemplary perspective view illustrating the external appearance of the electronic apparatus of the embodiment;

FIG. 3 is an exemplary view illustrating an example of close proximity wireless transfer which is executed between the electronic apparatus of the embodiment and an external device;

FIG. 4 is an exemplary view illustrating an example of a software architecture for controlling close proximity wireless transfer, which is applied to the electronic apparatus of the embodiment;

FIG. 5 is an exemplary perspective view illustrating a structure example of an induction electric field antenna (coupler) which is used in the electronic apparatus of the embodiment;

FIG. 6 is an exemplary perspective view illustrating a structure example of a millimeter-wave array antenna which is used in the electronic apparatus of the embodiment;

FIG. 7 is an exemplary plan view illustrating the millimeter-wave array antenna of FIG. 6;

FIG. 8 is an exemplary front view illustrating the millimeter-wave array antenna of FIG. 6;

FIG. 9 is an exemplary cross-sectional view of the electronic apparatus of the embodiment;

FIG. 10 is an exemplary view illustrating a positional relationship between the induction electric field antenna of FIG. 5 and the millimeter-wave array antenna of FIG. 6;

FIG. 11 is an exemplary view for describing the communication range which is covered by the millimeter-wave array antenna of FIG. 6; and

FIG. 12 is an exemplary view illustrating a cable wiring of the induction electric field antenna of FIG. 5.

### DETAILED DESCRIPTION

Various embodiments will be described hereinafter with reference to the accompanying drawings.

In general, according to one embodiment, an electronic apparatus comprises a housing with a first surface, an induction electric field antenna, a millimeter-wave antenna, and a close proximity wireless transfer unit. The induction electric field antenna is provided in the housing and comprises a coupling electrode facing a first region of the first surface. The millimeter-wave antenna is provided in the housing and is arranged opposed to the first region with the induction electric field antenna between the first region and the millimeter-wave antenna. The millimeter-wave antenna comprises a plurality of millimeter-wave antenna elements. The plurality of millimeter-wave antenna elements are disposed at positions outside an outer periphery of a bottom surface of the induction electric field antenna such that a space near the first region is included in a cover area of the millimeter-wave antenna. The close proximity wireless transfer unit is provided in the housing and is configured to transmit and receive wireless signals of a first frequency band via the induction electric field antenna and to transmit and receive wireless signals of a millimeter-wave band higher than the first frequency band, via the millimeter-wave antenna.

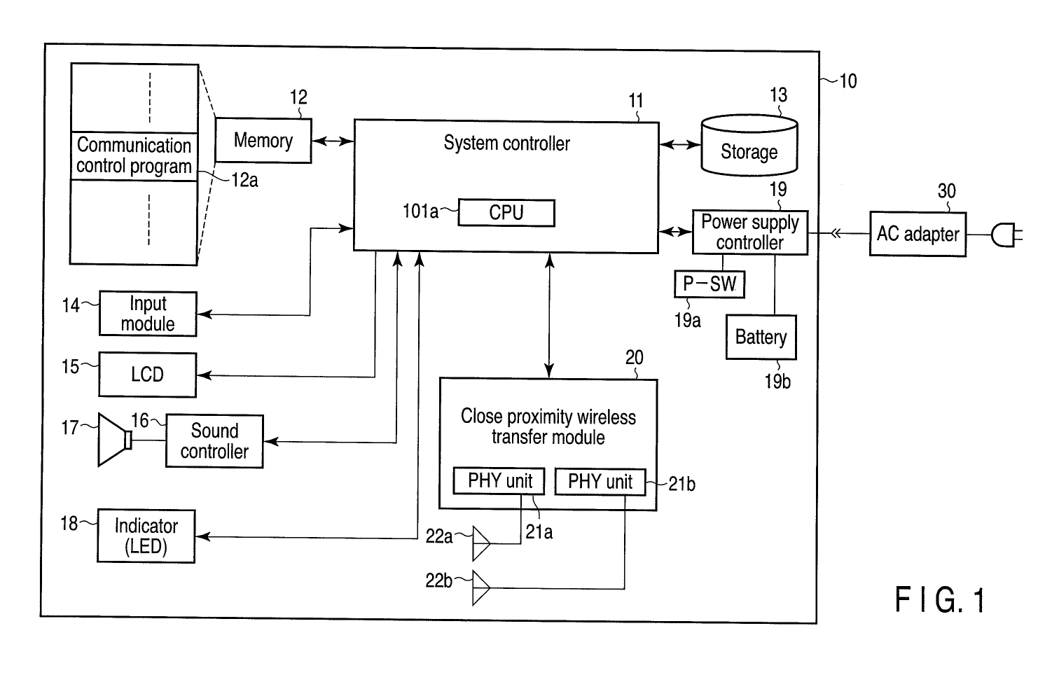

To begin with, referring to FIG. 1, the structure of an electronic apparatus according to an embodiment is described. The electronic apparatus 10 is realized, for example, as a portable computer, a mobile phone, a PDA, an audio player, or a TV. The electronic apparatus 10 comprises a system controller 11, a memory 12, a storage device 13, an input module 14, a liquid crystal display (LCD) 15, a sound controller 16, a speaker 17, an indicator 18, a power supply controller 19, and a close proximity wireless transfer module 20.

The system controller 11 controls the operations of the respective components in the electronic apparatus 10. The system controller 11 is connected to the memory 12, storage device 13, input module 14, LCD 15, sound controller 16, indicator 18, power supply controller 19 and close proximity wireless transfer module 20. The system controller 11 includes a CPU 101a.

The CPU 101a is a processor which executes an operating system, various application programs and utility programs, which are loaded from the storage device 13 into the memory 12. The application programs and utility programs include a communication control program 12a for controlling the communication operation of the close proximity wireless transfer module 20.

The communication control program 12a controls close proximity wireless transfer between an arbitrary electronic device (external device) having a close proximity wireless transfer function and the close proximity wireless transfer module 20. The storage device 13 is composed of, e.g. a hard disk drive or a nonvolatile semiconductor memory. The input module 14 is an input device for inputting data and an instruction, which are to be delivered to the CPU 111. The input module 14 is realized, for example, by a keyboard, a plurality of button switches, or a pointing device.

The LCD 15 is a display device which is used as a display of the electronic apparatus 10. The sound controller 16 is a sound source circuit for producing sound corresponding to audio data which is sent from the CPU 101a. The sound controller 16 converts the audio data, which is sent from the CPU 101a, from a digital audio signal to an analog audio signal, and outputs the analog audio signal to the speaker 17. The speaker 17 produces sound corresponding to the analog audio signal.

The indicator 18 presents the state (e.g. the start of data transfer, the end of data transfer, etc.) of close proximity wireless transfer which is executed by the close proximity wireless transfer module 20. A light emission module, such as an LED, may be used as the indicator 18.

The power supply controller 19 supplies power to the respective components in the electronic apparatus 10 by using power which is supplied from the outside via an AC adapter 30 or power which is supplied from a battery 19b provided in the electronic apparatus 10. In other words, the electronic apparatus 10 is driven by an external power supply such as an AC commercial power supply, or by the battery 19b. The AC adapter 30 may be provided within the electronic apparatus 10. The power supply controller 19 powers on or powers off the electronic apparatus 10 in accordance with an operation of a power switch (P-SW) 19a by the user.

The close proximity wireless transfer module 20 is a close proximity wireless transfer unit which executes close proximity wireless transfer. The close proximity wireless transfer module 20 can communicate with some other device (external device) having a close proximity wireless transfer function, which is present within a predetermined distance of communication (range of communication) from the close proximity wireless transfer module 20. The wireless communication between the close proximity wireless transfer module 20 and the external device is enabled only when the close proximity wireless transfer module 20 and the external device are in a close proximity state, that is, only when the distance between the close proximity wireless transfer module 20 and the external device is decreased to the range of communication (e.g. 3 cm) or less. When the close proximity wireless transfer module 20 and the external device are brought close together within the range of communication, the operation of establishing a connection (wireless connection) between the close proximity wireless transfer module 20 and the external device is started. After the connection (wireless connection) between the devices is established, a service, such as data transfer using SCSI, OBEX or other general-purpose protocol, is executed by the close proximity wireless transfer between the close proximity wireless transfer module 20 and the external device.

The close proximity wireless transfer module 20 is configured to support both close proximity wireless transfer using an induction electric field, and close proximity ultra-high-speed wireless transfer using millimeter waves. The close proximity wireless transfer module 20 is connected to an induction electric field antenna 22a and a millimeter-wave antenna 22b.

The induction electric field antenna 22a is an antenna called “coupler”, and is configured to cover a UWB band (about 4 GHz). The close proximity wireless transfer module 20 is configured to transmit and receive wireless signals of a first frequency band (e.g. an UWB band of about 4 GHz) via the induction electric field antenna 22a. When the external device comes near within the range of communication (e.g. 3 cm) from the induction electric field antenna 22a, the induction electric field antennas (couplers) of the close proximity wireless transfer module 20 and the external device are coupled by an induction electric field, and thereby wireless communication between the close proximity wireless transfer module 20 and the external device is enabled. The induction electric field antenna 22a comprises, for example, a coupling electrode and a ground plane which is disposed under the coupling electrode. An induction electric field is emitted from the coupling electrode. The ground plane is disposed such that the upper surface of the ground plane faces the lower surface of the coupling electrode.

The millimeter-wave antenna 22b is configured to cover a millimeter-wave band (e.g. 60 GHz band) which is higher than the first frequency band (UWB band). The millimeter-wave antenna 22b is used in order to transmit and receive signals (radio waves) of millimeter-wave band. The millimeter-wave antenna 22b, like the induction electric field antenna 22a, is used for close proximity wireless transfer with the external device. The millimeter-wave antenna 22b normally uses radio waves of the millimeter-wave band, that is, a radiation electric field of the millimeter-wave band. In principle, the millimeter-wave antenna 22b can cover an area of about 10 m from the millimeter-wave antenna 22b. In the present embodiment, however, since the millimeter-wave antenna 22b is designed for close proximity wireless transfer, the range of communication of the millimeter-wave antenna 22b is set to be relatively narrow, for example, by reducing power of a millimeter-wave transmission signal. The range of communication of the millimeter-wave antenna 22b may be set at, e.g. about 5 cm, which is longer than the range of communication of the induction electric field antenna 22a. The close proximity wireless transfer module 20 transmits and receives wireless signals of the millimeter-wave band via the millimeter-wave antenna 22b.

The close proximity wireless transfer module 20 and the induction electric field antenna 22a are connected via an antenna cable such as a coaxial cable.

Millimeter-wave signals tend to easily attenuate. Thus, if the close proximity wireless transfer module 20 and the millimeter-wave antenna 22b are connected via a coaxial cable, it is possible that the communication capability deteriorates due to attenuation of transmission signals and reception signals. In order to reduce as much as possible the attenuation of the transmission signals and reception signals, the millimeter-wave antenna 22b may be attached to a package of a chip (transceiver chip) including a millimeter-wave wireless circuit such as a millimeter-wave RF amplifier. The millimeter-wave wireless circuit is an RF circuit for transmitting and receiving millimeter waves. The millimeter-wave antenna 22b and the chip may be electrically connected via a bonding wire, etc. The close proximity wireless transfer module 20 is connected to the chip, on which the millimeter-wave antenna 22b is formed, via one or more signal lines.

Needless to say, the structure of the millimeter-wave antenna 22b is not limited to the above-described example, and other arbitrary structures may be adopted.

As a close proximity wireless transfer method using an induction electric field, TransferJet™, for instance, can be used. TransferJet™ is a close proximity wireless transfer method which uses an UWB, and data transfer can be executed at an effective transfer speed of about 373 Mbps. The close proximity ultra-high-speed wireless transfer may also be executed by using a wireless transfer method which is identical or similar to the close proximity wireless transfer method using the induction electric field.

The close proximity wireless transfer module 20 includes a PHY unit 21a and a PHY unit 21b. The PHY unit 21a is a wireless circuit for physically transmitting and receiving signals by using an induction electric field. The PHY unit 21b is a wireless circuit for physically transmitting and receiving signals by using millimeter waves. As has been described above, in the case where the antenna elements of the millimeter-wave antenna 22b are provided on the surface of the package of the chip including the millimeter-wave wireless circuit or in the package of the chip, some or all of the functions of the PHY unit 21b may be implemented by a millimeter-wave wireless circuit of the chip.

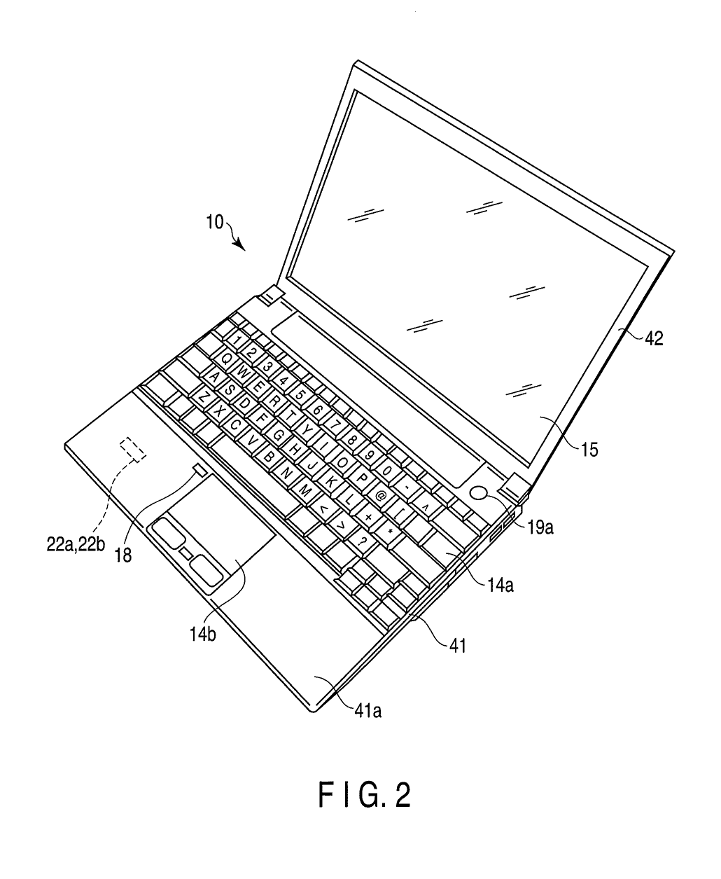

Next, referring to FIG. 2, an example of the external appearance of the electronic apparatus 10 is described, assuming that the electronic apparatus 10 is realized as a portable personal computer.

FIG. 2 is a perspective view showing the external appearance of the electronic apparatus 10. The electronic apparatus 10 comprises a main body 41 and a display unit 42. The display unit 42 is attached to the main body 41 such that the display unit 42 is rotatable between an open position where the top surface of the main body 41 is exposed, and a closed position where the top surface of the main body 41 is covered by the display unit 42. The above-described LCD 15 is provided in the display unit 42.

The main body 41 has a thin box-shaped housing. A keyboard 14a, a touch pad 14b, indicator 18 and power switch 19a are disposed on the top surface of the housing of the main body 41.

A part of a first surface of the housing of the main body 41, or in other words, a first region of a top surface 41a of the housing, functions as a touch point for close proximity wireless transfer between the devices. The close proximity wireless transfer between the electronic apparatus 10 and external device is executed, triggered by an operation (“touch”) of bringing an external device close to the first region (touch point) of the top surface 41a of the housing.

If the external device supports only the close proximity wireless transfer using an induction electric field, the electronic apparatus 10 (close proximity wireless transfer module 20) executes close proximity wireless transfer with the external device by using the induction electric field. If the external device supports only the close proximity wireless transfer using millimeter waves, the electronic apparatus 10 (close proximity wireless transfer module 20) executes close proximity wireless transfer with the external device by using the millimeter waves. If the external device supports both the close proximity wireless transfer using an induction electric field and the close proximity wireless transfer using millimeter waves, the electronic apparatus 10 (close proximity wireless transfer module 20) executes close proximity wireless transfer with the external device by using the millimeter waves, or executes close proximity wireless transfer with the external device by using the combination of an induction electric field and millimeter waves. In this case, the communication for establishing and releasing a connection between the devices may be executed by the close proximity wireless transfer using an induction electric field, and the data transfer between the devices may be executed by the close proximity ultra-high-speed wireless transfer using millimeter waves. Besides, in the data transfer, too, selective use may be made of the close proximity wireless transfer using an induction electric field and the close proximity ultra-high-speed wireless transfer using millimeter waves. For example, the close proximity wireless transfer using an induction electric field and the close proximity ultra-high-speed wireless transfer using millimeter waves may selectively be executed according to the kind of communication protocol for use in the data transfer between the devices, the kind of data that is a transfer target, or the amount of data that is a transfer target. For example, the close proximity ultra-high-speed wireless transfer using millimeter waves may be used when data transfer which requires a high data rate, such as non-compression transfer of HD images, is executed. Whether the close proximity wireless transfer using an induction electric field or the close proximity ultra-high-speed wireless transfer using millimeter waves is to be used may be determined by negotiations between the devices.

The system components shown in FIG. 1 are built in the housing of the main body 41. In the present embodiment, in order that both the close proximity wireless transfer using an induction electric field and the close proximity wireless transfer (close proximity ultra-high-speed wireless transfer) using millimeter waves can be executed via the same touch point, the induction electric field antenna 22a and millimeter-wave antenna 22b are disposed within the housing at a position corresponding to a part under the touch point on the top surface 41a of the housing.

Specifically, the induction electric field antenna 22a is provided within the housing so as to be opposed to the top surface 41a of the housing. The distance of communication (range of communication) of the induction electric field antenna 22a is shorter than the distance of communication (range of communication) of the millimeter-wave antenna 22b. Accordingly, in the present embodiment, the induction electric field antenna 22a is disposed at a position close to the top surface 41a of the housing.

The induction electric field antenna 22a includes the coupling electrode, as described above. The induction electric field antenna 22a is disposed such that the top surface of the coupling electrode is opposed to the first region of the top surface 41a of the housing. A small region of the top surface 41a of the housing, to which the coupling electrode is opposed, that is, the above-described first region, is sued as a touch point. The cover area of the induction electric field antenna 22a is a space near the first region of the top surface 41a, that is, the range of the neighborhood of the touch point.

The millimeter-wave antenna 22b is disposed within the housing of the main body 41 such that the millimeter-wave antenna 22b is located under the bottom surface (ground plane) of the induction electric field antenna 22a. The directivity and rectilinearity of the millimeter-wave antenna 22b are high, and the induction electric field antenna 22a is disposed near the top surface 41a of the housing, as described above. If the millimeter-wave antenna 22b is disposed on the same plane as the induction electric field antenna 22a, almost the entire space near the upper surface 41a may be included in the non-cover area of the millimeter-wave antenna 22b. In other words, almost the entire space near the first region (touch point) may not be covered by the millimeter-wave antenna 22b. This means that the above-described touch point cannot be shared between the close proximity wireless transfer using an induction electric field and the close proximity wireless transfer using millimeter waves.

Therefore, in the present embodiment, the millimeter-wave antenna 22b is provided at a position under the bottom surface of the induction electric field antenna 22a, or in other words, at a position within the housing on that side of the induction electric field antenna 22a, which is opposite to the side of the induction electric field antenna 22a facing the first region. That is, the millimeter-wave antenna 22b is arranged opposed to the first region with the induction electric field antenna 22a between the first region and the millimeter-wave antenna 22b.

Furthermore, the millimeter-wave antenna 22b comprises a plurality of millimeter-wave antenna elements arranged at positions outside the outer periphery of the bottom surface of the induction electric field antenna 22a, so that the space near the first region may be included in the cover area of the millimeter-wave antenna 22b.

To be more specific, in the present embodiment, the plural millimeter-wave antenna elements, which constitute the millimeter-wave antenna 22b, are disposed at positions which are farther from the top surface 41a of the housing than the bottom surface (ground plane) of the induction electric field antenna 22a and which are outside the outer periphery of the bottom surface of the induction electric field antenna 22a, so that the space near the first region may be covered by the plural millimeter-wave antenna elements. Accordingly, the distance (vertical distance) between the first region (touch point) and each of the millimeter-wave antenna elements in the direction vertical to the top surface 41a is longer than the distance (vertical distance) between the first region (touch point) and bottom surface (ground plane) of the induction electric field 22a in the direction vertical to the top surface 41a. Since the cover area of the millimeter-wave antenna 22b becomes larger as the distance from the millimeter-wave antenna 22b increases, the space near the top surface 41a can fully be covered by the millimeter-wave antenna 22b by disposing the millimeter-wave antenna 22b at a position which is farther from the top surface 41a of the housing than the bottom surface (ground plane) of the induction electric field antenna 22a.

Moreover, the directivity (directivity angle) of each of the millimeter-wave antenna elements is so set that, for example, all the radio wave radiation areas (cover areas) of the millimeter-wave antenna elements may overlap at a position which is away from the first region (touch point) to the outside by a predetermined distance, thereby to prevent the radio wave radiation areas of the respective millimeter-wave antenna elements from overlapping the induction electric field antenna 22a and to prevent a non-cover area of the millimeter-wave antenna 22b from occurring at positions which are away from the first region (touch point) to the outside by the predetermined distance. In this case, each of the positions, which are away from the first region (touch point) to the outside by the predetermined distance, means a position (assumed position) of a millimeter-wave antenna within the external device at a time when the external device is brought close to the touch point of the electronic apparatus 10.

In the meantime, in order to prevent the radio wave radiation areas of the respective millimeter-wave antenna elements from overlapping the induction electric field 22a and to prevent a non-cover area of the millimeter-wave antenna 22b from occurring at positions which are away from the first region (touch point) to the outside by the predetermined distance, it is possible to adjust not only the directivity (directivity angle) of each of the millimeter-wave antenna elements 22b, but also the distance (vertical distance) between the bottom surface (ground plane) of the induction electric field antenna 22a and the millimeter-wave antenna 22b in the direction vertical to the top surface 41a.

By the above-described arrangement of the induction electric field antenna 22a and the millimeter-wave antenna 22b, it becomes possible to execute, with the use of the same touch point, both the close proximity wireless transfer using an induction electric field and close proximity ultra-high-speed wireless transfer using millimeter waves, without causing mutual influences between both close proximity wireless transfers.

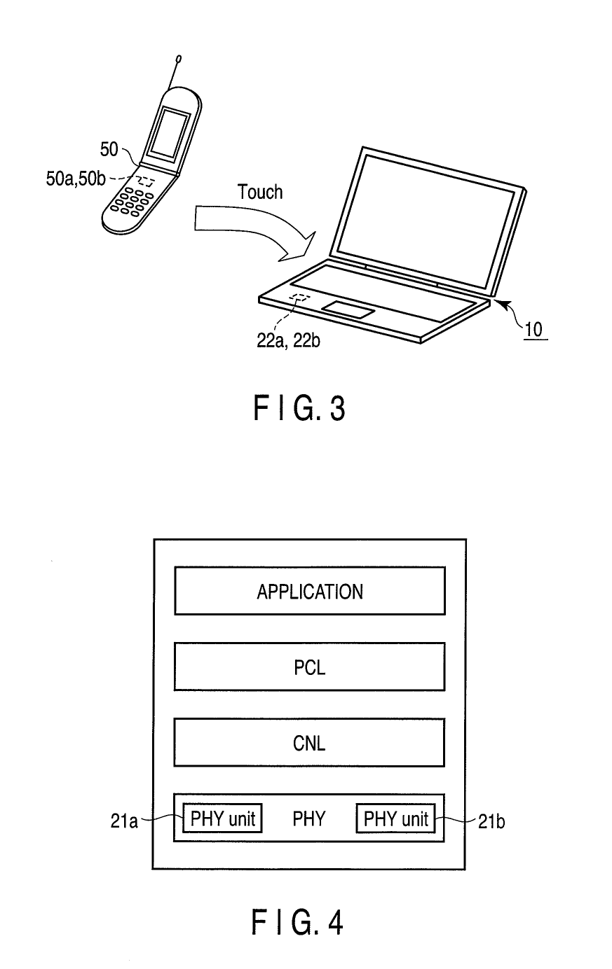

FIG. 3 illustrates close proximity wireless transfer which is executed between a mobile phone 50 and the electronic apparatus 10. An induction electric field antenna and a millimeter-wave antenna are provided within the housing of the mobile phone 50, for example. The arrangement of the induction electric field antenna and millimeter-wave antenna within the housing of the mobile phone 50 is the same as the arrangement of the induction electric field antenna 22a and millimeter-wave antenna 22b within the electronic apparatus 10. Specifically, in the mobile phone 50, the induction electric field antenna is disposed so as to be opposed to a first surface (e.g. back surface) of the housing of the mobile phone 50, and the millimeter-wave antenna is provided at a position under the bottom surface of the induction electric field antenna, that is, at a position which is farther from the back surface of the housing than the bottom surface of the induction electric field antenna.

Close proximity wireless transfer (close proximity wireless transfer using an induction electric field and close proximity ultra-high-speed wireless transfer using millimeter waves) between the mobile phone 50 and electronic apparatus 10 can be started by bringing the back surface of the housing of the mobile phone 50 over the touch point on the top surface 41a of the main body 41 of the electronic apparatus 10 (or by placing the mobile phone 50 on the top surface 41a).

Next, referring to FIG. 4, a description is given of a software architecture for controlling close proximity wireless transfer and close proximity ultra-high-speed wireless transfer, which are executed with use of the close proximity wireless transfer module 20.

The software architecture of FIG. 4 shows a hierarchical structure of a protocol stack for communication control. The protocol stack comprises a physical layer (PHY), a connection layer (CNL), a protocol conversion layer (PCL), and an application layer.

The physical layer (PHY) is a layer which controls physical data transfer, and corresponds to a physical layer in an OSI reference model. A part or all of the functions of the physical layer (PHY) may also be realized by using hardware in the close proximity wireless transfer module 20. The physical layer (PHY) includes the above-described PHY unit 21a for controlling physical data transfer using an induction electric field, and the above-described PHY unit 21b for controlling physical data transfer using millimeter waves.

The physical layer (PHY) converts data received from the connection layer (CNL) to a wireless signal. The connection layer (CNL) corresponds to a data link layer and a transport layer in the OSI reference model, and executes data communication by controlling the physical layer (PHY). Responding to a connection request which is received from the protocol conversion layer (PCL) or a connection request which is received from the external device, the connection layer (CNL) executes a process of establishing a (physical) connection between the close proximity wireless transfer module 20 and the external device, which are set in a close proximity state.

The protocol conversion layer (PCL) corresponds to a session layer and a presentation layer in the OSI reference model, and is positioned between the application layer and the connection layer (CNL). The protocol conversion layer (PCL) may be realized by the above-described connection control program 121. In order to establish the connection between the two devices, the protocol conversion layer (PCL) executes control of each application (communication program) in the application layer, and executes control of the connection layer (CNL).

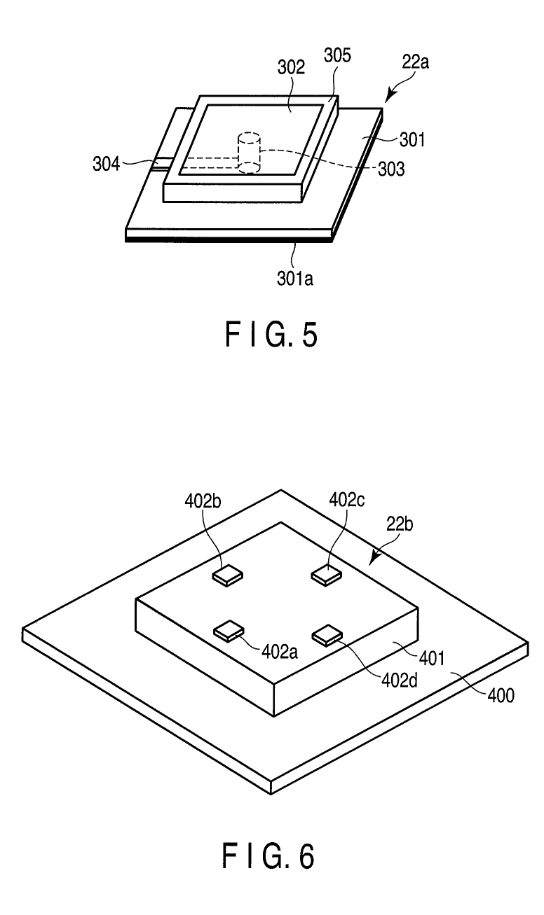

Next, referring to FIG. 5, a structure example of the induction electric field antenna 22a is described.

The induction electric field antenna 22a shown in FIG. 5 comprises a ground plane 301a and a coupling electrode 302. The ground plane 301a is provided on, for example, a bottom surface of a printed circuit board 301. The coupling electrode 302 is disposed on a top surface of the board 301 via a dielectric body 305. Thus, a top surface of the ground plane 301a is opposed to a bottom surface of the coupling electrode 302 via the board 301 and dielectric body 305. The coupling electrode 302 is electrically connected to a wiring 304 on the printed circuit board 301 via a through-hole 303 which is inserted in the dielectric body 305. The wiring 304 is connected to an antenna cable, such as a coaxial cable, via a connector or the like.

The structure of the induction electric field antenna 22a shown in FIG. 5 is an example, and the structure of the induction electric field antenna 22a is not limited to the example of FIG. 5. It should suffice if the induction electric field antenna 22a comprises at least the coupling electrode 302 and the ground plane 301a which is disposed under the coupling electrode 302. The induction electric field antenna 22a may adopt an arbitrary structure other than the structure of FIG. 5.

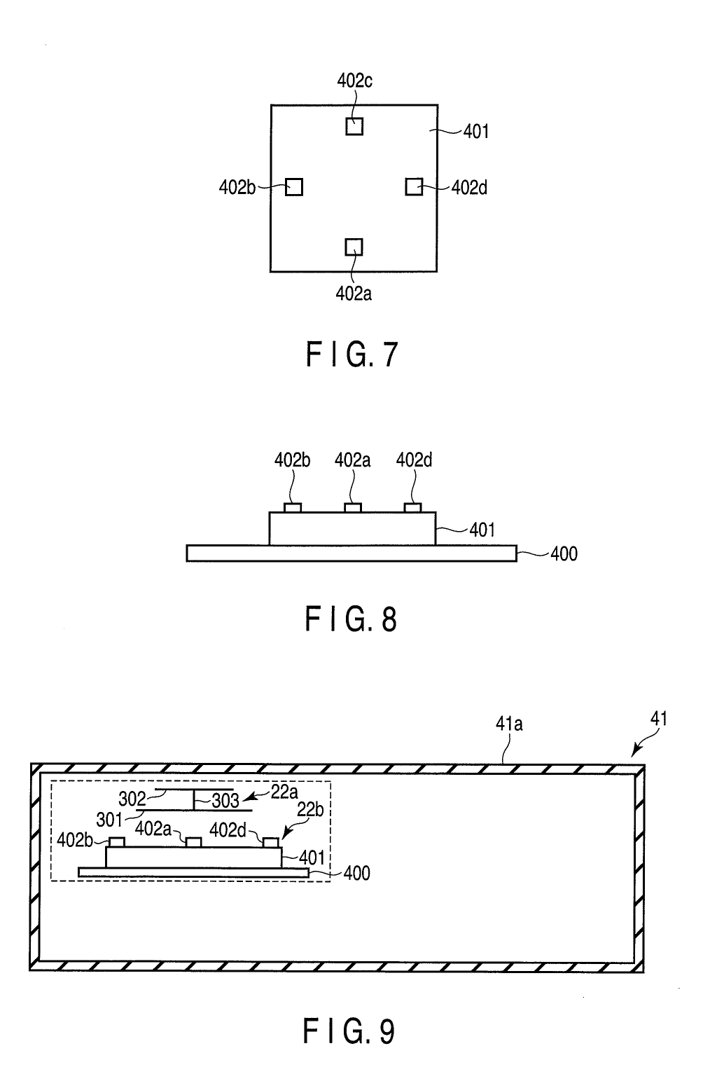

Next, referring to FIG. 6, FIG. 7 and FIG. 8, a structure example of the millimeter-wave antenna 22b is described. FIG. 6 is a perspective view of the millimeter-wave antenna 22b, FIG. 7 is a plan view of the millimeter-wave antenna 22b, and FIG. 8 is a front view of the millimeter-wave antenna 22b.

The frequency of signals, which are transmitted/received by the millimeter-wave antenna 22b, is very high (e.g. 60 GHz). Thus, if such a structure is adopted that the wireless circuit (RF circuit) for transmitting and receiving millimeter waves and the millimeter-wave antenna 22b are connected via a coaxial cable, the attenuation of signals increases and, as a result, the communication capability deteriorates. To cope with this, in the present embodiment, use is made of the millimeter-wave antenna 22b including millimeter-wave antenna element amounted on the surface of, or in the inside of, the package of the chip in which the wireless circuit (RF circuit) including an RF amplifier for millimeter waves is implemented. In addition, since the frequency of millimeter waves is close to the frequency of light and the directivity and rectilinearity of millimeter waves are high, the range which is covered by one small antenna element disposed on the chip is narrow. Thus, in the present embodiment, as has been described above, the millimeter-wave antenna 22b includes a plurality of millimeter-wave antenna elements. These millimeter-wave antenna elements may be mounted on the surface of the package of the chip, or in the inside of the package of the chip. In this case, the millimeter-wave antenna 22b functions as a millimeter-wave array antenna (also referred to as “millimeter-wave on-chip array antenna”).

In a structure example shown in FIG. 6, the millimeter-wave antenna 22b comprises a printed circuit board 400, a chip 401, and four millimeter-wave antenna elements 402a, 402b, 402c and 402d. The number of millimeter-wave antenna elements is not limited to four. For example, about several tens of millimeter-wave antenna elements may be provided. The four millimeter-wave antenna elements 402a, 402b, 402c and 402d may be disposed, for example, in the vicinity of the outer peripheral edge of the upper surface of the package of the chip 401.

In the meantime, the millimeter-wave antenna elements 402a, 402b, 402c and 402d may be disposed on the printed circuit board 400, and the millimeter-wave antenna elements 402a, 402b, 402c and 402d and the chip 401 may be connected via signal wiring lines on the printed circuit board 400.

FIG. 9 shows an example of amounting of the induction electric field antenna 22a and millimeter-wave antenna 22b within the housing of the main body 41.

If the millimeter-wave antenna elements of the millimeter-wave antenna 22b are disposed immediately under the induction electric field antenna 22a, the induction electric field antenna 22a becomes an obstacle to a millimeter-wave signal, and communication using millimeter waves cannot be executed.

Conversely, if the induction electric field antenna 22a is disposed immediately under the millimeter-wave antenna 22b, the distance between the top surface 41a of the housing and the induction electric field antenna 22a becomes excessively greater than a proper distance. Moreover, even if an external device is brought close to the top surface 41a of the housing, the induction electric field antenna 22a may not be coupled to an induction electric antenna of the external device, owing to the influence of the millimeter-wave antenna 22b.

In the present embodiment, as shown in FIG. 9, the induction electric field antenna 22a, which has a shorter range of communication than the millimeter-wave antenna 22b, is disposed at a position closest to the top surface 41a of the housing. The induction electric field antenna 22a is attached to the position near the top surface 41a by an attachment structure which uses no metal (e.g. metal rod). In addition, the millimeter-wave antenna (millimeter-wave on-chip array antenna) 22b is disposed immediately under the induction electric field antenna 22a. Specifically, the millimeter-wave antenna 22b is disposed to be opposed to the lower surface of the ground plane 301a which is disposed on the bottom surface of the induction electric field antenna 22a.

As the size of the package of the chip 401 of the millimeter-wave antenna (millimeter-wave on-chip array antenna) 22b, use may be made of a size greater than the size of the bottom surface (ground plane 301a) of the millimeter-wave antenna 22b. In this case, by the structure in which the millimeter-wave antenna elements 402a, 402b, 402c and 402d are disposed along the outer edge portion of the surface of the package of the chip 401, the millimeter-wave antenna elements 402a, 402b, 402c and 402d can be positioned outside the outer periphery of the bottom surface (ground plane 301a) of the induction electric field antenna 22a.

In the meantime, it is possible to realize a single independent antenna unit including the induction electric field antenna 22a and millimeter-wave antenna (millimeter-wave on-chip array antenna) 22b which are arranged in a multilayer fashion as shown in FIG. 9. In this case, the mounting structure shown in FIG. 9 can easily be realized by simply providing this antenna unit within the main body 41 such that the top surface of the antenna unit is opposed to the top surface 41a of the housing of the main body 41. The antenna unit includes an antenna housing indicated by a broken line in FIG. 9. The antenna housing is disposed such that the top surface of the antenna housing is opposed to the first region of the top surface 41a of the housing of the main body 41. Accordingly, the top surface of the antenna housing is used as a kind of touch point.

The induction electric field antenna 22a is disposed within the antenna housing such that the top surface of the coupling electrode 302 is opposed to the top surface of the antenna housing. The millimeter-wave antenna 22b is disposed under the bottom surface of the induction electric field antenna 22a, that is, on that side of the induction electric field antenna 22a, which is opposite to the side of induction electric field antenna 22a facing the top surface of the antenna housing. That is, the millimeter-wave antenna 22b is arranged opposed to the top surface of the antenna housing with the induction electric field antenna 22a between the top surface of the antenna housing and the millimeter-wave antenna 22b.

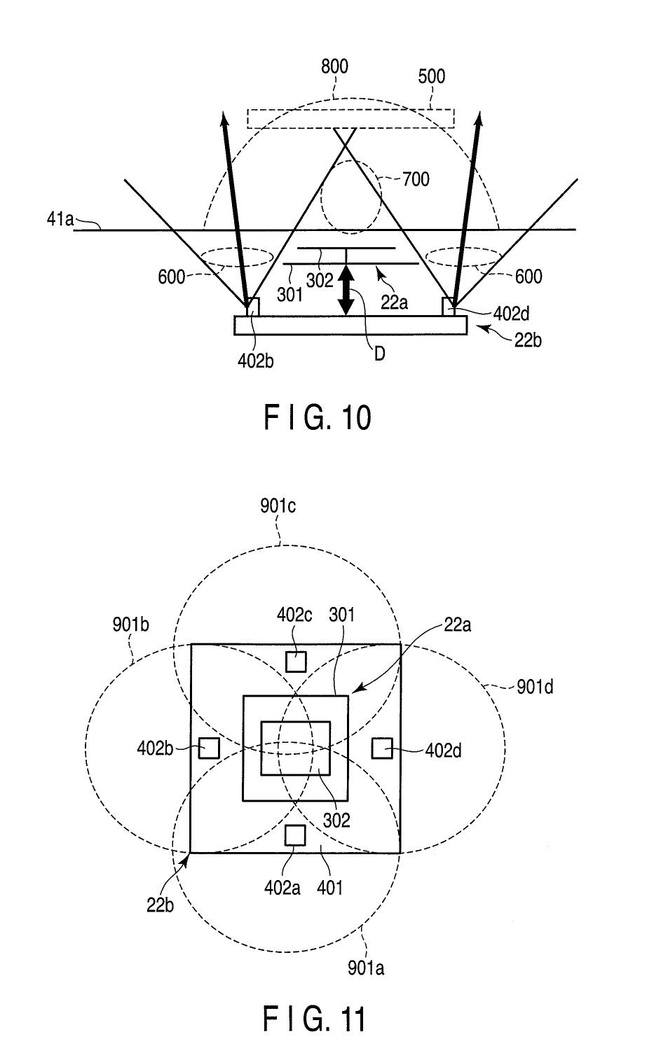

FIG. 10 illustrates an example of the positional relationship between the induction electric field antenna 22a and millimeter-wave antenna 22b. In FIG. 10, reference numeral 500 denotes an assumed position of a millimeter-wave antenna within an external device in the state in which the external device is in physical contact with the electronic apparatus 10. In addition, in FIG. 10, reference numeral 600 denotes cover areas of the millimeter-wave antenna elements 402a, 402b, 402c and 402d, numeral 700 denotes a non-cover area of the millimeter-wave antenna elements 402a, 402b, 402c and 402d, and numeral 800 denotes a cover area of the induction electric field antenna 22a. As described above, the directivity (directivity angle) of each of the millimeter-wave antenna elements 402a, 402b, 402c and 402d is so adjusted that the radio wave radiation areas (cover areas) 600 of the millimeter-wave antenna elements 402a, 402b, 402c and 402d may not overlap the induction electric field antenna 22a and that the cover areas 600 of all millimeter-wave antenna elements 402a, 402b, 402c and 402d may overlap at the assumed position 500 of the millimeter-wave antenna of the target external device, without creating a non-cover area. Besides, a distance D between the induction electric field antenna 22a and millimeter-wave antenna 22b is so adjusted that the radio wave radiation areas (cover areas) 600 of the millimeter-wave antenna elements 402a, 402b, 402c and 402d may not overlap the induction electric field antenna 22a and that the cover areas 600 of all millimeter-wave antenna elements 402a, 402b, 402c and 402d may overlap at the assumed position 500 of the millimeter-wave antenna of the target external device, without creating a non-cover area.

FIG. 11 is a plan view illustrating the cover area of the millimeter-wave antenna 22b at the assumed position (height position) of the millimeter-wave antenna of the target external device. In FIG. 11, reference numerals 901a, 901b, 901c and 901d denote cover areas of the millimeter-wave antenna elements 402a, 402b, 402c and 402d at the assumed height position of the millimeter-wave antenna of the target external device.

As has been described above, as shown in FIG. 10, the non-cover area 700, which is not covered by the millimeter-wave antenna 22b, may occur in the space immediately above the touch point on the top surface 41a of the housing. However, since the assumed height position of the millimeter-wave antenna of the target external device is higher than the non-cover area 700, the non-cover area 700 does not affect the close proximity wireless transfer using millimeter waves.

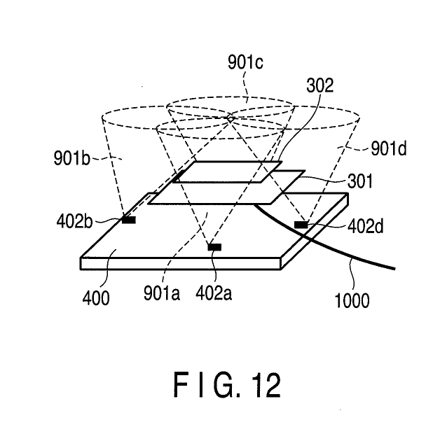

FIG. 12 illustrates the positional relationship between the cover areas 901a, 901b, 901c and 901d corresponding to the millimeter-wave antenna elements 402a, 402b, 402c and 402d and an antenna cable 1000 which is connected to the induction electric field antenna 22a.

As has been described above, the induction electric field antenna 22a includes the antenna cable 1000 which is electrically connected to the coupling electrode 302, and the induction electric field antenna 22a is connected to the close proximity wireless transfer module 20 via the antenna cable 1000. In this case, as shown in FIG. 12, the antenna cable 1000 is led out to the outside from the induction electric field antenna 22a so as not to overlap the cover areas 901a, 901b, 901c and 901d, that is, so as not to overlap the radio wave radiation areas of the millimeter-wave antenna elements 402a, 402b, 402c and 402d. For example, the antenna cable 1000 is led out to the outside through a gap between two neighboring millimeter-wave antenna elements. In this manner, by disposing the antenna cable 1000 in a manner to avoid the cover areas 901a, 901b, 901c and 901d, it becomes possible to prevent the antenna cable 1000 from affecting the close proximity wireless transfer using millimeter waves. The cover areas 901a, 901b, 901c and 901d correspond to the radio wave radiation areas of the millimeter-wave antenna elements 402a, 402b, 402c and 402d.

As has been described above, according to the present embodiment, the induction electric field antenna 22a is disposed such that the coupling electrode is opposed to the first region of the top surface 41a of the housing. The plural millimeter-wave antenna elements 402a, 402b, 402c and 402d, which are included in the millimeter-wave antenna 22b, are disposed at positions which are farther from the top surface 41a of the housing than the bottom surface (ground plane) of the induction electric field antenna 22a and which are outside the outer periphery of the bottom surface of the induction electric field antenna 22a, so that the space near the first region may be covered by the plural millimeter-wave antenna elements 402a, 402b, 402c and 402d. Accordingly, since not only the cover area of the induction electric field antenna 22a but also the cover area of the millimeter-wave antenna 22b can be created in the nearby space above the first region, it is possible to execute, with the use of the same touch point (first region), both the close proximity wireless transfer using millimeter waves and the close proximity wireless transfer using an induction electric field.

In the present embodiment, the description has been given of the configuration in which the single wireless transfer module 20 transmits and receives signals via the induction electric field antenna 22a, and transmits and receives signals via the millimeter-wave antenna 22b. Alternatively, the communication unit, which transmits and receives signals via the induction electric field antenna 22a, and the communication unit, which transmits and receives signals via the millimeter-wave antenna 22b, may be physically different units. In this case, these communication units function as the wireless transfer module 20.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing comprising a first surface;
a millimeter-wave antenna in a housing and opposite a first region of the first surface, the millimeter-wave antenna comprising a plurality of millimeter-wave antenna elements;
an induction electric field antenna in the housing between the first region and the millimeter-wave antenna, the induction electric field antenna comprising a coupling electrode facing the first region; and
a close proximity wireless transfer unit in the housing and configured to transmit and receive wireless signals of a first frequency band via the induction electric field antenna and to transmit and receive wireless signals of a millimeter-wave band, which is higher than the first frequency band, via the millimeter-wave antenna,
wherein the plurality of millimeter-wave antenna elements are outside an outer periphery of a bottom surface of the induction electric field antenna such that a cover area of the millimeter-wave antenna comprises the first region.

2. The electronic apparatus of claim 1, wherein the millimeter-wave antenna elements are directed such that radio wave radiation areas of the millimeter-wave antenna elements do not overlap the induction electric field antenna and that cover areas of the millimeter-wave antenna elements overlap at a first distance from the first region.

3. The electronic apparatus of claim 1,
wherein the millimeter-wave antenna comprises a printed circuit board, and
wherein the plurality of millimeter-wave antenna elements are on or within a package of a transceiver chip on the printed circuit board.

4. The electronic apparatus of claim 1,
wherein the induction electric field antenna comprises an antenna cable which is electrically connected to the coupling electrode, and
wherein the antenna cable does not pass through cover areas of the millimeter-wave antenna elements.

5. The electronic apparatus of claim 1,
wherein the induction electric field antenna comprises a ground plane which opposite the coupling electrode, the ground plane comprising a top surface on the bottom surface of the induction electric field antenna, and
wherein the millimeter-wave antenna is opposite a lower surface of the ground plane.

6. An antenna unit comprising:
an antenna housing comprising a first surface;
a millimeter-wave antenna in the antenna housing, opposite the first surface, the millimeter-wave antenna comprising a plurality of millimeter-wave antenna elements; and
an induction electric field antenna in the antenna housing between the first surface and the millimeter-wave antenna, the induction electric field antenna comprising a coupling electrode facing the first surface,
wherein the plurality of millimeter-wave antenna elements are outside an outer periphery of a bottom surface of the induction electric field antenna such that a cover area of the millimeter-wave antenna comprises the first surface.

7. The antenna unit of claim 6, wherein the millimeter-wave antenna elements are directed such that radio wave radiation areas of the millimeter-wave antenna elements do not overlap the induction electric field antenna and that cover areas of the millimeter-wave antenna elements overlap at a first distance from the first region.
